(19) United States
(12) Patent Application Publication
(10) Pub. No.: US 2025/0316068 A1
(43) Pub. Date: Oct. 9, 2025

(54) METHOD, DEVICE, AND SYSTEM WITH IMAGE PROCESSING TASK PERFORMANCE

(71) Applicant: Samsung Electronics Co., Ltd., Suwon-si (KR)

(72) Inventors: Xiaoshuai HAO, Beijing (CN); Chaoqun ZHUANG, Beijing (CN); Hui ZHANG, Beijing (CN); Weiming LI, Beijing (CN); Byung In YOO, Suwon-si (KR); Seungin PARK, Suwon-si (KR); Sangil JUNG, Suwon-si (KR)

(73) Assignee: Samsung Electronics Co., Ltd., Suwon-si (KR)

(21) Appl. No.: 19/077,993

(22) Filed: Mar. 12, 2025

(30) Foreign Application Priority Data
Apr. 8, 2024 (CN) 202410418350.3
Oct. 18, 2024 (KR) 10-2024-0143343

(51) Int. Cl. G06V 10/80; G06V 10/70; G06V 10/72; G06V 10/77

(52) U.S. Cl. CPC G06V 10/806; G06V 10/72; G06V 10/7715; G06V 10/87

(57) ABSTRACT

A method, device, and system with image processing task performance are provided. The electronic system includes one or more processors, and a memory storing code for performing at least two image processing tasks with respect to an image, wherein execution of the code by the one or more processors causes the one or more processors to extract an image feature of the image, respectively generate a spatial feature and a channel feature dependent on the image feature, generate a fused feature, for the image, dependent on the spatial feature and the channel feature, and generate respective results of the at least two image processing tasks based on a corresponding customized task feature for each of the at least two image processing tasks generated using the fused feature.

### CROSS-REFERENCE TO RELATED APPLICATIONS

This application claims the benefit under 35 USC § 119 (a) of Chinese Patent Application No. 202410418350.3, filed on Apr. 8, 2024, in the China National Intellectual Property Administration, and Korean Patent Application No. 10-2024-0143343, filed on Oct. 18, 2024, in the Korean Intellectual Property Office, the entire disclosures of which are incorporated herein by reference for all purposes.

### BACKGROUND

### 1. Field

The following description relates to a method, device, and system with image processing task performance.

### 2. Description of Related Art

Image processing in computer vision technology is performed in various fields including autonomous driving. In general, such image processing technologies may include various types of image processing tasks.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electronic system includes one or more processors, and a memory storing code for performing at least two image processing tasks with respect to an image, wherein execution of the code by the one or more processors causes the one or more processors to extract an image feature of the image, respectively generate a spatial feature and a channel feature dependent on the image feature, generate a fused feature, for the image, dependent on the spatial feature and the channel feature, and generate respective results of the at least two image processing tasks based on a corresponding customized task feature for each of the at least two image processing tasks generated using the fused feature.

For the generation of the spatial feature, the execution of the code may configure the processor to determine a first representative value by performing, in a channel dimension, a first operation using the image feature, determine a second representative value by performing, in the channel dimension, a second operation using the image feature, generate a spatial weight matrix using the first representative value and the second representative value, and generate the spatial feature using the spatial weight matrix and the image feature.

The first operation may be a max pooling applied, in the channel direction, to the image feature, and the second operation may be an average pooling applied, in the channel direction, to the image feature.

The execution of the code may configure the processor to determine a third representative value by performing, in a spatial dimension, a third operation using the image feature, determine a fourth representative value by performing, in the spatial dimension, a fourth operation using the image feature, generate a channel weight matrix based on a relationship between channels that may be learned using the third representative value and the fourth representative value, and generate the channel feature using the channel weight matrix and the image feature.

The third operation may be a max pooling applied, in the spatial direction, to the image feature, and the fourth operation may be an average pooling applied, in the spatial direction, to the image feature.

The execution of the code may configure the processor to generate a first fused feature by fusing, in a channel dimension, the spatial feature with the channel feature, perform a fifth operation using the first fused feature, determine a respective weight for each channel of the first fused feature by learning a relationship between channels by performing a sixth operation using a result of the performed fifth operation, and generate the fused feature by applying the respective weight for each channel to the first fused feature.

The performing of the fifth operation may include performing global average pooling on the first fused feature, a first linear transformation on a result of the global average pooling, and a second linear transformation on a result of the first linear transformation to have a feature size equal to a feature size of the result of the global average pooling, and the sixth operation may include applying an activation function to the result of the performed fifth operation.

The execution of the code may configure the processor to respectively select at least one specialized model for each of the at least two image processing tasks by using a corresponding routing function of each of the at least two image processing tasks, set a respective weight for the respectively selected at least one specialized model for each of the at least two image processing tasks, and generate the corresponding customized task feature for each of the at least two image processing tasks by fusing, according to the set respective weight for the respectively selected at least one specialized model for each of the at least two image processing tasks, results of processing the fused feature by the respectively selected at least one specialized model for each of the at least two image processing tasks.

The execution of the code may configure the processor to normalize the fused feature, and generate the corresponding customized task feature for each of the at least two image processing tasks by fusing, according to the set respective weight for the respectively selected at least one specialized model for each of the at least two image processing tasks, results of processing the normalized fused feature by the respectively selected at least one specialized model for each of the at least two image processing tasks.

A routing function, among the corresponding routing functions, and a specialized model, among the respectively selected at least one specialized model for each of the at least two image processing tasks, may be implemented as a multilayer perceptron (MLP).

The extraction of the image feature, the respective generation of the spatial feature and the channel feature, the generation of the fused feature, and the generation of the respective results of the at least two image processing tasks may be performed using an artificial intelligence (AI) model that was trained based on respective classification losses of the at least two image processing tasks and a class-balanced loss through adjustment of hyperparameters of an in-training AI model based on the respective classification losses and the class-balanced loss.

The generating of the respective results of the at least two image processing tasks may include performing the generating of the corresponding customized task feature for each of the at least two image processing tasks, and respectively decoding the corresponding customized task feature for each of the at least two image processing tasks to generate the respective results of the at least two image processing tasks.

In one general aspect, a processor-implemented method for performing at least two image processing tasks with respect to an image includes extracting an image feature of the image, respectively generating a spatial feature and a channel feature dependent on the image feature, generating a fused feature, for the image, dependent on the spatial feature and the channel feature, and generating respective results of the at least two image processing tasks based on a corresponding customized task feature for each of the at least two image processing tasks generated using the fused feature.

The generating of the spatial feature may include determining a first representative value by performing, in a channel dimension, a first operation using the image feature, determining a second representative value by performing, in the channel dimension, a second operation using the image feature, generating a spatial weight matrix using the first representative value and the second representative value, and generating the spatial feature using the spatial weight matrix and the image feature.

The generating of the channel feature may include determining a third representative value by performing, in a spatial dimension, a third operation using the image feature, determining a fourth representative value by performing, in the spatial dimension, a fourth operation using the image feature, generating a channel weight matrix based on a relationship between channels that may be learned using the third representative value and the fourth representative value, and generating the channel feature using the channel weight matrix and the image feature.

The generating of the fused feature may include generating a first fused feature by fusing, in a channel direction, the spatial feature with the channel feature, performing a fifth operation using the first fused feature, determining a respective weight for each channel of the first fused feature by learning a relationship between channels by performing a sixth operation using a result of the performed fifth operation, and generating the fused feature for the image by applying the respective weight for each channel to the first fused feature.

The generating of the respective customized task features may include respectively selecting at least one specialized model for each of the at least two image processing tasks by using a corresponding routing function of each of the at least two image processing tasks, setting a respective weight for the respectively selected at least one specialized model for each of the at least two image processing task, and generating the corresponding customized task feature for each of the at least two image processing tasks by fusing, according to the set respective weight for the respectively selected at least one specialized model for each of the at least two image processing tasks, results of processing the fused feature by the respectively selected at least one specialized model for each of the at least two image processing tasks.

The method may further include normalizing the fused feature, and the generating of the corresponding customized task features for each of the at least two image processing tasks may include generating the corresponding customized task features for each of the at least two image processing tasks by fusing, according to the set respective weight for the respectively selected at least one specialized model for each of the at least two image processing tasks, results of processing the normalized fused feature by the respectively selected at least one specialized model for each of the at least two image processing tasks.

A routing function, among the corresponding routing functions, and a specialized model, among the respectively selected at least one specialized model for each of the at least two image processing tasks, may be implemented as a multilayer perceptron (MLP).

The extracting of the image feature, the respective generating of the spatial feature and the channel feature, the generating of the fused feature, and the generating of the respective results of the at least two image processing tasks may be performed using an artificial intelligence (AI) model.

Other features and aspects will be apparent from the following detailed description, the drawings, and the claims.

### BRIEF DESCRIPTION OF THE DRAWINGS

FIG. 1 illustrates an example electronic device that performs an image processing task according to one or more embodiments.

FIG. 2 illustrates example results of processing tasks performed with respect to an image according to one or more embodiments.

FIG. 3 illustrates an example method of an image processing task according to one or more embodiments.

FIG. 4 illustrates an example artificial intelligence (AI) model according to one or more embodiments.

FIG. 5 illustrates an example spatial feature enhancement operation of an AI model according to one or more embodiments.

FIG. 6 illustrates an example channel feature enhancement operation of an AI model according to one or more embodiments.

FIG. 7 illustrates an example fused feature generation operation of an AI model according to one or more embodiments.

FIG. 8 illustrates an example task feature derivation operation of an AI model according to one or more embodiments.

FIG. 9 illustrates an example result of an image processing task performed using an AI model according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings (e.g., each phrase may include any one of the respective items alone, all of the items listed together, and all possible combinations thereof), and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

As noted above, image processing technologies may include various types of image processing tasks. High accuracy and/or real-time performance are found to be desirable in many of such image processing tasks. For example, in a panoramic driving perception system embodiment of an example vehicle, both high accuracy and real-time performance of various image processing tasks may be desirable to realize greater safety during autonomous driving.

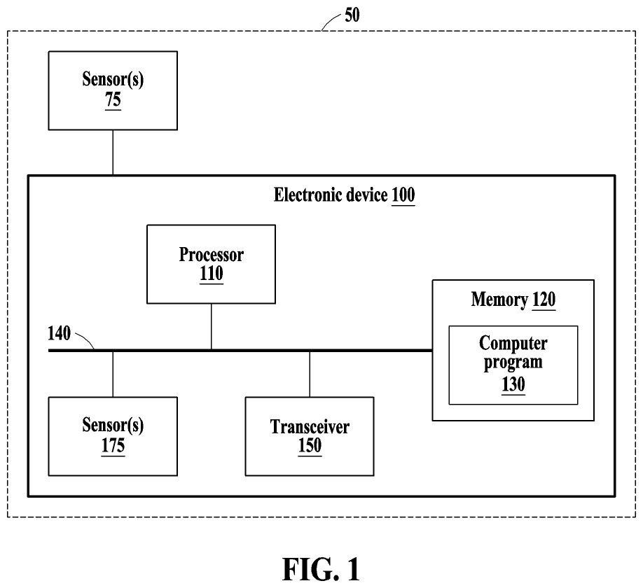

FIG. 1 illustrates an example electronic device that performs an image processing task according to one or more embodiments.

Referring to FIG. 1, an electronic device 100 may include a processor 110 (i.e., representing one or more processors 110) and a memory 120 (i.e., representing one or more memories 120) that stores a computer program 130 (or code) that when executed by the processor 110 configures the processor 110 to perform any one, any combination, or all operations or methods described herein. The processor 110 and the memory 120 may be connected to each other through a hardware communication link (e.g., a bus) 140. The electronic device 100 may further include a transceiver 150, and the transceiver 150 may be used for data exchange, such as transmission and/or reception of data between the electronic device 100 and another electronic device (e.g., another electronic device 100 or sensor(s) 75). The electronic device 100 may further include sensor(s) 175. The sensor(s) 75 and/or 175 may respectively include one or more sensors that are configured to capture image data, for obtaining an image on which one or more image processing tasks, as described herein, may be performed. As a non-limiting example, such one or more sensors may include respective cameras configured to capture images of the environmental surroundings of the electronic device 100. The electronic device 100 and sensor(s) 75 may be included in an electronic system 50, or the processor 110, memory 120, and transceiver 150 may be components in the electronic system 50 without necessarily being enclosed in a single electronic device 100. As a non-limiting example, the electronic system 50 may be a vehicle, and the sensors(s) 75 may include one or more cameras capturing images of an environmental surroundings of the vehicle, such as a forward facing camera of the vehicle, and the electronic device 100 (or processor 110 or memory 120) may obtain an image (from among such captured images) on which one or more image processing tasks, as described herein, may be performed. In an example, the transceiver 150 may wiredly and/or wirelessly communicate with the sensor(s) 75 of the vehicle to obtain the image (from among such captured images) on which one or more image processing tasks, as described herein, may be performed. Below, while examples may be discussed with respect to performing image processing tasks on ‘an image’, which may be an image among such obtained images, the below examples are also applicable to performing such image processing tasks on each of multiple such obtained images. The components included in the electronic device 100 of FIG. 1 (or electronic system 50) are only non-limiting examples of the components included in the electronic device 100 (or electronic system 50), as additional components may further be included in addition to the components shown in FIG. 1.

The processor 110 may control the overall operation of each component of the electronic device 100. The processor 110 may include at least one of a central processing unit (CPU), a microprocessor unit (MPU), a microcontroller unit (MCU), a graphics processing unit (GPU), a neural processing unit (NPU), a digital signal processor (DSP), and/or other types of well-known processors in a relevant field of technology.

The memory 120 may store any one or any combination of two or more of various pieces of data, instructions (i.e., code), and pieces of information that are used the processor 110. The memory 120 may include volatile memory and/or non-volatile memory.

The program 130 may include code for one or more actions to implement the methods/operations described herein according to various examples and may be stored in the memory 120. In an example, operations may be implemented through execution of the program 130. For example, the program 130 may be or include instructions (i.e., code) that causes the processor 110 to perform an operation of extracting an image feature for an image, an operation of obtaining a spatial feature and a channel feature for the image using the extracted image features, an operation of generating a fused feature based on the spatial feature and the channel feature, an operation of deriving, using the fused feature, a customized task feature for each of at least two image processing tasks, and an operation of outputting, using the customized task feature, a result of each performed image processing task with respect to the image. Herein, the image feature, spatial feature, channel feature, fused feature, and customized task feature may each be multi-dimensional and each representative of multiple corresponding features. For example, the extracted image feature may represent a plurality of image features respectively extracted from the image.

For example, the program 130 may be loaded in the memory 120 (e.g., from another memory 120), the processor 110 may execute the program 130 and perform plurality of operations to implement the methods/operations described herein according to examples. The program 130 is also representative of one or more programs (or instructions/code) 130 to respectively perform any one or any combination of the respectively described operations herein.

The communication link 140 may provide a wired and/or wireless path for providing or transmitting at least one of various pieces of data, instructions, and pieces of information between components included in the electronic device 100, as well as with external electronic devices (e.g., other electronic devices 100). The communication link 140 may be, for example, a peripheral component interconnect (PCI) bus or an extended industry standard architecture (EISA) bus. However, these types of buses are only examples, and examples are not limited thereto. For example, referring to FIG. 1, while the communication link 140 is illustrated as a bus and represented by a single line, this is merely for ease of description, as the illustrated communication link 140 may be representative of a plurality of buses and/or various types of buses.

Some of the operations of the electronic device 100 provided in the present disclosure may be performed using an artificial intelligence (AI) model. For example, the processor 110 may process input data using an AI model stored in the memory 120. The AI model may be obtained by training the AI model with a plurality of pieces of training data through any well-known machine-learning training algorithm, such as through supervised, unsupervised, and/or reinforcement learning, where weights of the AI model may be adjusted (e.g., through backpropagation) during such training until the trained AI model demonstrates certain characteristics, such as certain levels of accuracy and/or inaccuracy.

The AI model may include one or more neural networks, each of which may include a plurality of neural network layers. Each of multiple layers of an example neural network may perform a corresponding neural network operation with respect to data that is input to a corresponding layer (e.g., as an operation result of a previous layer or data first input to the AI model), through the application of a plurality of weight values of the corresponding layer to the data that is input to the corresponding layer. For example, a neural network included in the AI model may include one or more of each of a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial network (GAN), and/or a deep Q-network (DQN). However, these types of neural networks are only an example, and examples are not limited thereto.

The electronic device 100 may obtain a result of performing an image processing task associated with an image, in response to the electronic device inputting the image to the AI model. In an example, the electronic device 100 may enhance image processing speed using the AI model that was pre-trained to perform a plurality of image processing tasks simultaneously (or in parallel), compared to previous approaches to performing image processing tasks individually and/or without such an AI model.

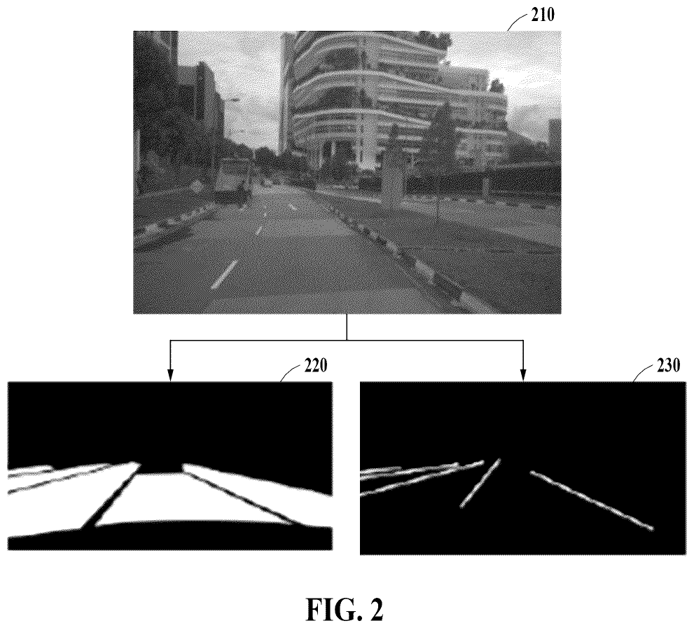

For example, as illustrated in FIG. 2, the electronic device 100 may simultaneously obtain a drivable area segmentation result 220 and a lane segmentation result 230 from a single red, green, and blue (RGB) camera image 210 using an AI model that was pre-trained to simultaneously perform a drivable area segmentation task and a lane segmentation task, which are image processing tasks that may be related to autonomous driving.

Various image processing tasks related to autonomous driving may often include interrelated information. One or more embodiments may include performing such various image processing tasks using an AI model that performs a plurality of image processing tasks with respect to a single image, which may enhance processing speed of each image processing task by sharing features, extracted from the image by the AI model, within the AI model.

Referring to FIG. 2, the drivable area segmentation result 220 may be generated by performing a drivable area segmentation task that may include an identifying of an area, within an image, in which a vehicle can physically drive or traverse, and the lane segmentation result 230 may be generated by performing a lane segmentation task that may include an identifying of a boundary of such a drivable area. The AI model may accelerate an image processing process, according to one or more embodiments, by simultaneously processing, using shared features that are derived from the image, such different image processing tasks that include or depend on interrelated information.

For example, an electronic device according to one or more embodiments may perform such drivable area segmentation and lane segmentation tasks simultaneously using an AI model that was previously trained (pre-trained) to perform such image processing tasks using enhanced and fused image features (as such shared features) extracted from an image input to the AI model. Use of such an AI model may provide high precision and real-time performance of image processing. For example, the AI model may be configured to enhance an image feature extracted from an image into a spatial feature and a channel feature, fuse the spatial feature with the channel feature, and perform an image processing task on the image based on the resultant fused feature. In this example, by using such pre-trained AI models, the electronic device may provide a result of the performed image processing tasks with high precision and real-time performance (e.g., while the vehicle is being operated or driven, or performing autonomous or semi-autonomous operations of the vehicle).

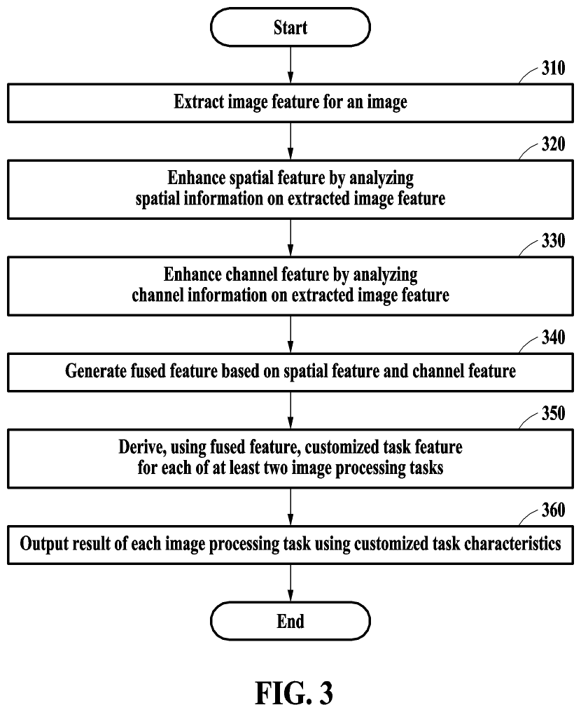

FIG. 3 illustrates an example method of an image processing task according to one or more embodiments. One or more of the operations of FIG. 3 may be simultaneously or parallelly performed with one another, and the order of the operations may be changed. In addition, at least one of the illustrated operations may be omitted and/or other operation(s) may be additionally or alternatively performed. As a non-limiting example, the operations illustrated in FIG. 3 may be performed by a processor (e.g., the processor 110 of the electronic device 100 or electronic system 50 of FIG. 1).

In operation 310, the processor may extract an image feature for an image. More specifically, the processor may obtain an image from a sensor (e.g., a camera, or sensor(s) 75 and/or 175 of FIG. 1) of a vehicle (e.g., the electronic system 50 of FIG. 1) in which the electronic device is disposed or from a sensor outside the vehicle (e.g., a camera of another vehicle, or sensors(s) 75 and/or 175 of FIG. 1 of another electronic device 100 or another electronic system 50). The obtaining of the image can include the processor (or other components of the electronic device 100 or electronic system 50 of FIG. 1, such as stored in the memory 120 or by using the transceiver 150 of FIG. 1) requesting and/or receiving the image captured by the sensor. In an example, the image may be an RGB image of the surroundings of the vehicle captured by and received from the camera of the vehicle. However, the method of obtaining an image or the type of image described above is only an example, and examples are not limited thereto. For example, an image may be captured by and received from a sensor of another vehicle, a sensor operated by a pedestrian, or a sensor mounted on an object along the pathway of the vehicle, and may be received in various forms, such as an RGB image, an infrared image, light detection and ranging (LIDAR) data, or depth and/or object position and/or velocity detection respectively from an RGB camera, an infrared camera, LIDAR camera, or radar or ultrasonic sensors (as examples of the sensor(s) 75 and 175 of FIG. 1), as non-limiting examples.

The processor may extract an image feature from the image, using a feature extraction model. For example, the image may be an RGB image and may be expressed as I=R^{H*W*C}. Here, R indicates that the image is an RGB image, and H, W, and C denote a height, a width, and a number of channels of the image, respectively. The image feature for the image, extracted through the feature extraction model, may be expressed as F_{I}∈R^{H/8×W/8×C}. However, the form of the image feature is only an example, and examples are not limited thereto.

In operation 320, the processor may enhance a spatial feature for the image by analyzing spatial information of the extracted image feature. For example, the processor may determine a degree of importance of each of a plurality of pixels (e.g., of all pixels) in the image to the corresponding image by analyzing the spatial information of the extracted image feature.

In operation 330, the processor may enhance a channel feature for the image by analyzing channel information of the extracted image feature. For example, the processor may determine a degree of importance of each channel in the image to the corresponding image by analyzing the channel information of the extracted image feature.

In operation 340, the processor may generate a fused feature for the image, based on the spatial feature and the channel feature. For example, the processor may generate an initial fused feature by fusing the spatial feature with the channel feature in a channel dimension. The processor may determine a weight for each channel by processing, according to predetermined criteria, the initial fused feature generated. The processor may generate final fused feature for the image by applying the determined weight for each channel to the initial fused feature.

In operation 350, the processor may derive, using the fused feature, a customized task feature for each of at least two image processing tasks. In this case, the at least two image processing tasks may be highly related image processing tasks. For example, the at least two image processing tasks may include a drivable area segmentation task and a lane segmentation task, which are highly related to each other, in an example where the image is related to an example autonomous driving operation of the vehicle (e.g., in an example controlling of the driving of the vehicle based on the image, and more particularly, based on the respective results of the performed drivable area segmentation task and the lane segmentation task).

In operation 360, the processor may output the respective results of the performed at least two image processing tasks, using customized task characteristics. For example, the processor may perform a decoding of the derived task feature customized for a corresponding image processing task, using a decoder corresponding to each image processing task.

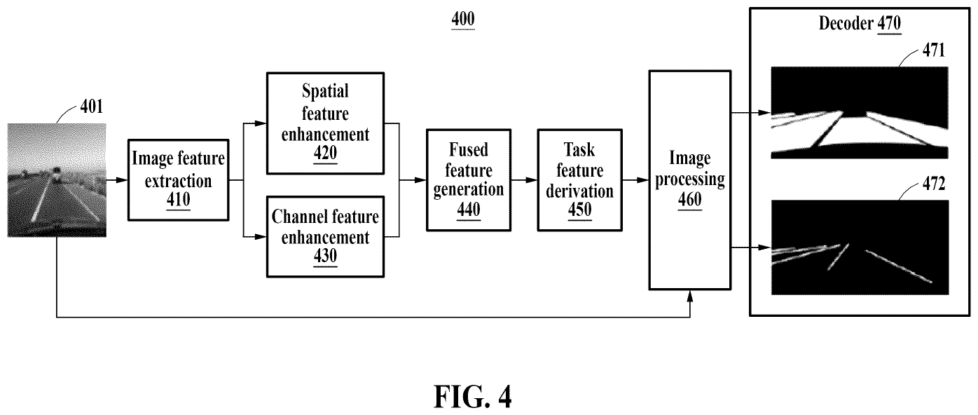

FIG. 4 illustrates an example AI model according to one or more embodiments.

Referring to FIG. 4, an AI model 400 may be an AI model that has been pre-trained to perform a plurality of image processing tasks simultaneously (or in parallel).

The AI model 400 may perform an image feature extraction operation 410 on an input image 401. For example, the AI model 400 may extract an image feature for the input image 401, such as by using an efficient spatial pyramid network (ESPNet) model to perform the image feature extraction operation 410. Here, the ESPNet model may be a feature extraction model that extracts image feature from an image by integrating information between various input dimensions of the image and mapping the integrated information to a feature space. However, the type of feature extraction model in the AI model 400 is only an example, and examples are not limited thereto.

Typical image processing approaches may perform a single image processing task by extracting image feature from an input image, through a typical feature extraction model, and directly thereafter inputting the extracted image feature to a decoder, an output of which would be the final result of the single image processing task. However, although such typical image processing approaches may provide an excellent image processing performance, performing image processing in real time with such typical image processing approaches may be difficult.

An AI model 400 according to various embodiments may enhance image processing speed by reducing the total number of parameters of the feature extraction model (e.g., compared to such a typical feature extraction model), such as by lightening or pruning approaches, thereby reducing the total number of computations that are performed to generate the extracted feature, which may also increase real-time performance of the underlying image processing task. The number of computations may also be reduced through quantization, for example, of the parameters (e.g., weights and/or biases). For example, while the ESPNet model may have a set number of parameters and number of computations, in an example a modified ESPNet model (with a reduced number of parameters and number of computations) may be used to perform the image feature extraction operation 410. However, when the total number of parameters of the typical feature extraction model are reduced, there may be a decrease in the quality or amount of information that is extracted from the input image 401 in the resultant extracted image feature, thereby degrading image processing performance.

The AI model 400 may perform feature enhancement(s) on the image feature extracted by the image feature extraction operation 410. Such feature enhancement may also compensate for an example decrease in the quality and amount of information represented in the extracted image feature when such a modified ESPNet model is used in an embodiment to perform the image feature extraction operation 410, which may prevent degradation of image processing performance due to the example decrease in the quality and amount of information represented in the extracted image feature.

As one example of the performed feature enhancement, the AI model 400 may perform a spatial feature enhancement operation 420 using the image feature extracted through the image feature extraction operation 410. For example, the AI model 400 may enhance a spatial feature for the input image 401, using a spatial attention mechanism (e.g., model or model portion) that applies higher weightings to determined important areas in the input image 401 to enhance the extracted image feature of those important areas. However, this structure of the model used to enhance spatial feature in the AI model 400 is only an example, and examples are not limited thereto.

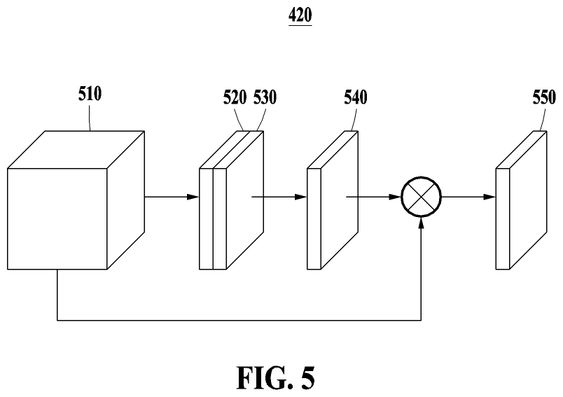

As an example of the spatial attention mechanism, FIG. 5 illustrates an example spatial feature enhancement operation of an AI model according to one or more embodiments.

As a non-limiting example, the spatial feature enhancement operation of FIG. 5 may correspond to the spatial feature enhancement operation 420 of the AI model 400 of FIG. 4, and for explanatory purposes will be described based on the same. The AI model 400 may generate a spatial feature 550 for the input image 401, using an image feature 510 of the input image 401 (e.g., extracted through the image feature extraction operation 410 of FIG. 4). For example, when an image feature for an RGB image extracted through the image feature extraction operation 410 is F_{I}∈R^{H/8×W/8×C}, the AI model 400 may generate the spatial feature 550 for the input image 401, using the image feature 510 of size B*C*H/8*W/8 Here, B denotes a batch size.

The AI model 400 may determine a first representative value by processing the image feature 510 in a channel dimension according to a predetermined first method. For example, the AI model 400 may obtain the first representative value of size B*1*H/8*W/8 by applying max pooling 520 to the image feature 510 in the channel dimension.

The AI model 400 may determine a second representative value by processing the image feature 510 in the channel dimension according to a predetermined second method. For example, the AI model 400 may obtain the second representative value of size B*1*H/8*W/8 by applying average pooling 530 to the image feature 510 in the channel dimension.

The AI model 400 may cascade the first representative value and the second representative value obtained in the manner described above to obtain a result of size B*2*H/8*W/8 and may perform a convolution operation on the cascaded result. The AI model 400 may apply an activation function to a result of performing the convolution operation to generate a spatial weight matrix 540 of size B*1*H/8*W/8. The spatial weight matrix 540 generated in the manner described above may be expressed as M_{S}(F_{I}) and may represent a weight of a pixel for each channel of the input image 401. Here, pixels at same locations in different channels of the input image 401 may be given the same weight.

The AI model 400 may generate the spatial feature 550 for the input image 401, using the spatial weight matrix 540 and the image feature 510. For example, the AI model 400 may generate the spatial feature 550 for the input image 401 through an element-wise product of the spatial weight matrix 540 and the image feature 510, as shown in Equation 1 below.

$${F}^{′} = {M}_{s} ( {F}_{I} ) ⊗ {F}_{I} \qquad Equation 1$$

Here, F′ denotes the spatial feature 550 for the input image 401. The AI model 400 may enhance an expressive power for a wide range of contextual information of the entire input image 401, through the spatial feature 550.

Returning to FIG. 4, the AI model 400 may perform a channel feature enhancement operation 430 on the input image 401, using the image feature results from the image feature extraction operation 410. For example, the AI model 400 may enhance a channel feature for the input image 401, using a channel attention mechanism that gives a higher weight to an important channel in the input image 401. However, the structure of the model used to enhance a channel feature in the AI model 400 is only an example, and examples are not limited thereto.

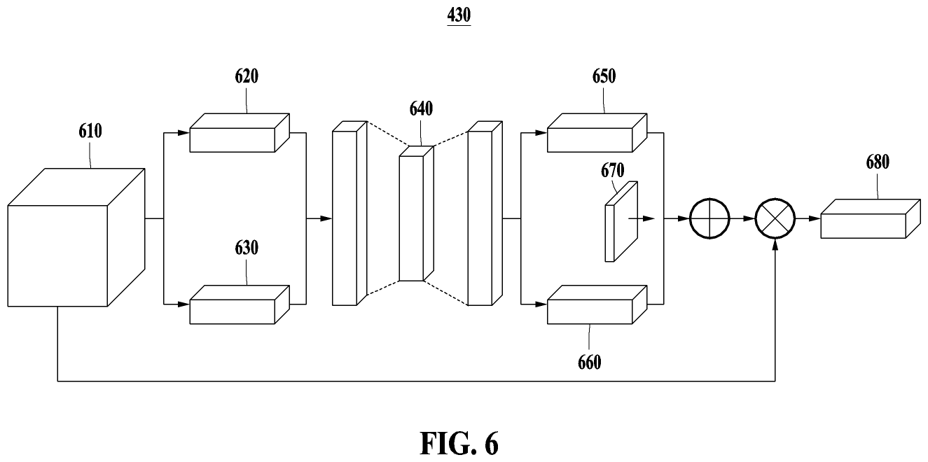

As an example of the channel attention mechanism, FIG. 6 illustrates an example channel feature enhancement operation of an AI model according to one or more embodiments.

As a non-limiting example, the channel feature enhancement operation of FIG. 6 may correspond to the channel feature enhancement operation 430 of the AI model 400 of FIG. 4, and for explanatory purposes will be described based on the same. The AI model 400 may generate a channel feature 680 for the input image 401, using an image feature 610 of the input image 401 (e.g., extracted through the image feature extraction operation 410 of FIG. 4). The image feature 610 may be, or identical to, the image feature 510 of FIG. 5.

For example, when an image feature for an RGB image extracted through the image feature extraction operation 410 is F_{I}∈R^{H/8×W/8×C}, the AI model 400 may generate the channel feature 680 for the input image 401, using the image feature 610 of size B*C*H/8*W/8. Here, B denotes a batch size.

The AI model 400 may determine a third representative value by processing the image feature 610 in a spatial dimension according to a predetermined third method. For example, the AI model 400 may obtain the third representative value of size B*C*1*1 by applying max pooling 620 to the image feature 610 in the spatial dimension.

The AI model 400 may determine a fourth representative value by processing the image feature 610 in a spatial dimension according to a predetermined fourth method. For example, the AI model 400 may obtain the fourth representative value of size B*C*1*1 by applying average pooling 630 to the image feature 610 in the spatial dimension.

The AI model 400 may output two learning results (e.g., a learning result 650 and a learning result 660) of size B*C*1*1 wherein the results are of a learned relationship between channels by applying the third representative value and the fourth representative value respectively to a neural network layer 640 that learns a relationship between channels. For example, the neural network layer 640 may output the learning result 650 of the relationship between channels by processing the third representative value, which may be a result of the max pooling 620, and may output the learning result 660 of the relationship between channels by processing the fourth representative value, which may be a result of the average pooling 630. Here, the neural network layer 640 may include a fully connected layer to generate the learning result 650 and the learning result 660. However, the form of the neural network layer 640 is only an example, and examples are not limited thereto.

The AI model 400 may generate a channel weight matrix 670 of size B*C*1*1, by combining the two learning results 650 and 660 output in this manner and applying an activation function to the combined outputs. The channel weight matrix 670 generated in this manner may be expressed as M_{C}(F_{I}) and may represent a weight of a channel for each pixel of the input image 401. Here, same channels in pixels at different locations of the input image 401 may be given a same weight.

The AI model 400 may generate a channel feature 680 for the input image 401, using the channel weight matrix 670 and the image feature 610. For example, the AI model 400 may generate the channel feature 680 for the input image 401 through an element-wise product of the channel weight matrix 670 and the image feature 610, as shown in Equation 2 below.

$${F}^{″} = {M}_{c} ( {F}_{I} ) ⊗ {F}_{I} \qquad Equation 2$$

Here, F″ denotes the channel feature 680 for the input image 401. The AI model 400 may enhance a specific semantic expression by using a dependency relationship between various channels in the input image 401 through the channel feature 680.

Returning to FIG. 4, the AI model 400 may generate a fused feature for the input image 401 by fusing a spatial feature with a channel feature through a fused feature generation operation 440.

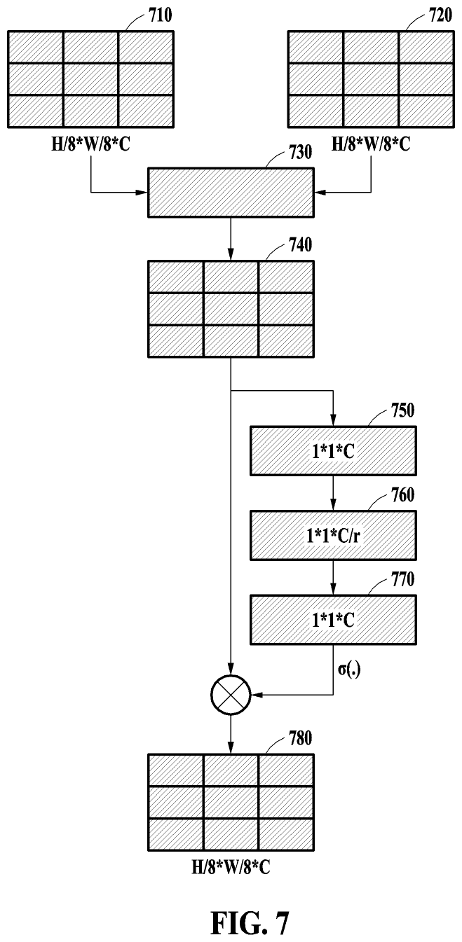

For example, FIG. 7 illustrates an example fused feature generation operation of an AI model according to one or more embodiments.

As a non-limiting example, the fused feature generation operation of FIG. 7 may correspond to the fused feature generation operation 440 of the AI model 400 of FIG. 4, and for explanatory purposes will be described based on the same. The AI model 400 may generate a final fused feature 780 for the input image 401, using a spatial feature 710 and a channel feature 720 of the input image 401, which are enhanced through the spatial feature enhancement operation 420 and the channel feature enhancement operation 430 of FIG. 4, for example. In an example, the spatial feature 710 may correspond to the spatial feature 550 of FIG. 5, and the channel feature 720 may correspond to the channel feature 680 of FIG. 6.

The AI model 400 may generate an initial fused feature 740 by performing a fusion operation 730 on the spatial feature 710 and the channel feature 720 of the input image 401 in a channel dimension. More specifically, the AI model 400 may cascade and combine the spatial feature 710 and the channel feature 720 in a channel dimension and may reduce the channel dimension of the two features as combined.

For example, the AI model 400 may cascade and combine the spatial feature 710 of size H/8*W/8*C. and the channel feature 720 of size H/8*W/8*C in the channel dimension and reduce the channel dimension through a space-channel fusion function to obtain the initial fused feature 740 of size H/8*W/8*C. Here, a process of obtaining the initial fused feature 740 may be expressed as f_{concat} [F_{PAM}, F_{CAM}] Here, F_{PAM} and I_{CAM} denote the spatial feature 710 and the channel feature 720, respectively, [⋅, ⋅] denotes a cascade operation, and f_{concat} may be a spatial-channel fusion function that combines the spatial feature 710 with the channel feature 720. For example, the spatial-channel fusion function may be implemented as a 3×3 convolutional layer and may reduce the channel dimension of the cascaded features to C. However, the implementation method of the spatial-channel fusion function is only an example, and examples are not limited thereto. The initial fused feature 740 obtained through f_{concat} [F_{PAM}, F_{CAM}] may be expressed as

$$\hat{F} = {R}^{\frac{H}{8} \times \frac{W}{8} * C} .$$

The AI model 400 may process the initial fused feature 740 of size H/8*W/8*C according to a predetermined fifth method. For example, the AI model 400 may obtain a feature of size 1*1*C by performing global average pooling 750 on the initial fused feature 740 of size H/8*W/8*C The AI model 400 may obtain a feature of size 1*1*C/r by performing linear transformation (e.g., linear mapping) 760 on the feature of size 1*1*C, and may subsequently obtain a feature of size 1*1*C again by performing linear transformation 770 on the feature of size 1*1*C/r.

The AI model 400 may learn a relationship between channels by processing, according to a predetermined sixth method, a result processed according to the predetermined fifth method to determine a weight for each channel of the initial fused feature 740. For example, the AI model 400 may determine the weight for each channel of the initial fused feature 740 by multiplying the feature of size 1*1*C which is a final result according to the predetermined fifth method, by an activation function (e.g., a sigmoid function). Here, a process of determining the weight for each channel of the initial fused feature 740 may be expressed as σ(Wf_{avg}(\hat{F})). Here, W denotes a linear transformation matrix (e.g., a 1×1 convolutional layer), f_{avg}(\hat{F}) denotes performing of the global average pooling 750 on, and \acute{F}, σ denotes the sigmoid function, which is an example activation function, as a non-limiting example.

The AI model 400 may generate the final fused feature 780 for the input image 401 by applying the weight determined for each channel of the initial fused feature 740 to the initial fused feature 740, as shown in Equation 3. Here, the final fused feature 780 generated may have a size of H/8*W/8*C.

$${f}_{adaptive} ( \hat{F} ) = σ ( {Wf}_{avg} ( \hat{F} ) ) \cdot \hat{F} \qquad Equation 3$$

Returning to FIG. 4, the AI model 400 may derive a customized task feature for each of at least two image processing tasks associated with the input image 401 through a task feature derivation operation 450.

Considering limited computational resources in a real-world environment, it may be more efficient to use a single framework that shares parameters (i.e., of the respective image processor task models) than to use individual frameworks for different image processing tasks. However, since there may be a difference in a characteristic of each task even among highly related image processing tasks, when different image processing tasks are performed using a fused feature directly, a conflict between tasks may occur and accordingly image processing performance may degrade.

The AI model 400 may select at least one specialized model for each image processing task by using a routing function corresponding to each of at least two image processing tasks. Here, a specialized model may refer to an image processing model that has a function specialized for a specific image processing task.

The AI model 400 may derive the customized task feature for each of at least two image processing tasks associated with the input image 401 by setting a weight for the selected specialized model and fusing, according to the weight, results of processing a fused feature by the selected specialized model.

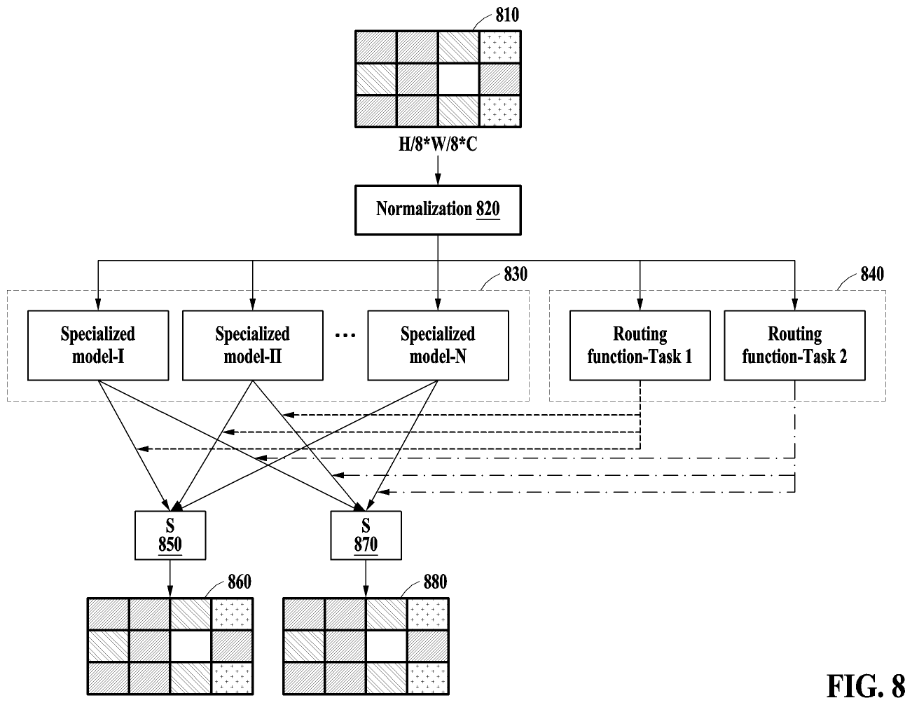

For example, FIG. 8 illustrates an example task feature derivation operation of an AI model according to one or more embodiments.

As a non-limiting example, the task feature derivation operation of FIG. 8 may correspond to the task feature derivation operation 450 of the AI model 400 of FIG. 4, and for explanatory purposes will be described based on the same. The AI model 400 may derive a customized task feature (e.g., a customized task feature 860 and a customized task feature 880, respectively) for each of at least two image processing tasks associated with the input image 401, using a fused feature 810 for the input image 401.

The AI model 400 may obtain a normalized fused feature 820 by performing normalization on the fused feature 810 of size H/8*W/8*C generated through the fused feature generation operation 440. In an example, the fused feature 810 may correspond to the fused feature 780 of FIG. 7.

The AI model 400 may select at least one specialized model 830 for each image processing task by using a routing function 840 corresponding to each image processing task. For example, the AI model 400 may select, from among N specialized models, at least one specialized model having a function specialized for processing a task 1, by using a routing function corresponding to the task 1 (e.g., Routing function-Task 1 of FIG. 8). Alternatively, the AI model 400 may select, from among N specialized models, at least one specialized model having a function specialized for processing a task 2, by using a routing function corresponding to the task 2 (e.g., Routing function-Task 2 of FIG. 8).

The AI model 400 may set a weight for at least one selected specialized model. To this end, the AI model 400 may predetermine a plurality of specialized models that may be used to perform a multi-image processing task on the input image 401. For example, the AI model 400 may predetermine N specialized models that may be used to perform the task 1 and the task 2, select at least one specialized model having a function specialized for processing the task 1, and set a weight for the selected specialized model. Alternatively, the AI model 400 may select, from among predetermined N specialized models, at least one specialized model having a function specialized for processing the task 2 and may set a weight for the selected specialized model. For example, the AI model 400 may select all N specialized models or select only some of the N specialized models, corresponding to the task 1 and the task 2.

The AI model 400 may predetermine, for each image processing task, a plurality of specialized models for processing the input image 401. For example, the AI model 400 may determine N1 specialized models having a function specialized for processing the task 1 for the input image 401 and may determine N2 specialized models having a function specialized for processing the task 2 for the input image 401. In this case, the AI model 400 may set a weight for each of the N1 specialized models, using a routing function corresponding to the task 1, and may set a weight for each of the N2 specialized models, using a routing function corresponding to the task 2.

The AI model 400 may derive the customized task feature for each of at least two image processing tasks associated with the input image 401 by fusing, according to the weight set for at least one specialized model selected, results of processing the normalized fused feature 820 by the corresponding specialized model. For example, the AI model 400 may derive the customized task feature 860 for the task 1 by fusing 850 the results of processing the normalized fused feature 820 by the specialized model selected through the routing function corresponding to the task 1, according to the weight set for the corresponding specialized model. Alternatively, the AI model 400 may derive the customized task feature 880 for the task 2 by fusing 870 the results of processing the normalized fused feature 820 by the specialized model selected through the routing function corresponding to the task 2, according to the weight set for the corresponding specialized model.

When the fused feature 810 or the normalized fused feature 820 is assumed to be x, a process of generating, based on x, the customized task feature for one of at least two image processing tasks may be expressed as in Equation 4 below.

$$M O {E}_{t} ( x ) = {\sum }_{i = 1}^{N} {t}_{} {( x )}_{i} {ε}_{i} ( x ) \qquad Equation 4$$

Here, MOEₜ(x) denotes a task feature having a function specialized for a task t(t=1, . . . , n, where n denotes a number of at least two image processing tasks), N denotes a number of specialized models, [symbol] denotes a routing function corresponding to the task t, [symbol] (x)ᵢ denotes a weight of i-th specialized model for the task t, and ϵᵢ(x) denotes a result of processing x by the i-th specialized model.

The specialized model and the routing function may be implemented as a multilayer perceptron layer (MLP). However, the structure of the specialized model and the routing function is only an example, and examples are not limited thereto.

The AI model 400 may output a performance result of each image processing task associated with the input image 401 through the image processing operation 460. For example, when the input image 401 is an image related to autonomous driving, the AI model 400 may obtain a drivable area segmentation task performance result 471 and a lane segmentation task performance result 472 by corresponding decoder(s) 470 of the AI model 400 (as component(s) of the image processing 460, even though illustrated separately from the image processing 460) decoding the customized task feature (e.g., a corresponding MOEₜ(x) of Equation 4) derived for each task, using each of a or respective decoder(s) 470 corresponding to a drivable area segmentation task and a lane segmentation task. However, the type of task that may be performed in response to the input image 401 is only an example, and examples are not limited thereto.

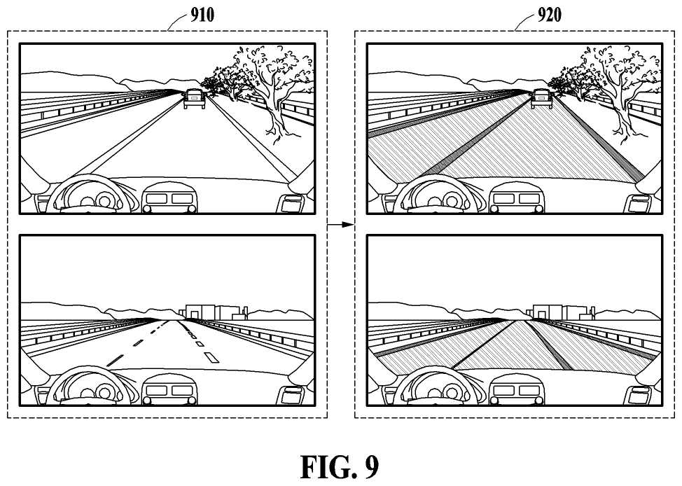

FIG. 9 illustrates an example result of an image processing task performed using an AI model according to one or more embodiments.

An electronic device (e.g., the electronic device 100 of FIG. 1 or the electronic system 50 of FIG. 1) may perform a drivable area segmentation task and a lane segmentation task on an input image 910 through an AI model and obtain a visualized drivable area segmentation result and a lane segmentation result 920. As an example, the AI model may correspond to the AI model 400 of FIG. 4.

The AI model may be trained, and/or have been, previously trained, using a class related to at least two image processing tasks. For example, one or more examples include training the AI model so that a loss value of a loss function [symbol] shown in Equation 5 below, may be minimized.

$$ℒ = {λ}_{1} {ℒ}_{Focal} + {λ}_{2} {ℒ}_{Tversky} \qquad Equation 5$$

Here, [symbol] _{Focal} denotes a classification loss of an image processing task, [symbol] _{Tversky} denotes a class-balanced loss, and λ₁ and λ₂ are hyperparameters for adjusting the classification loss and the class-balanced loss during a training process of the AI model. However, the form of loss function is only an example for training the AI model, and examples are not limited thereto.

The processors, memories, transceivers, hardware communication links and buses, and sensor and cameras described herein, including descriptions with respect to respect to FIGS. 1-9, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-9 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RW, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An electronic system comprising:
one or more processors; and
a memory storing code for performing at least two image processing tasks with respect to an image, wherein execution of the code by the one or more processors causes the one or more processors to:
extract an image feature of the image;
respectively generate a spatial feature and a channel feature dependent on the image feature;
generate a fused feature, for the image, dependent on the spatial feature and the channel feature; and
generate respective results of the at least two image processing tasks based on a corresponding customized task feature for each of the at least two image processing tasks generated using the fused feature.

2. The electronic system of claim 1, wherein, for the generation of the spatial feature, the execution of the code configures the processor to:
determine a first representative value by performing, in a channel dimension, a first operation using the image feature;
determine a second representative value by performing, in the channel dimension, a second operation using the image feature;
generate a spatial weight matrix using the first representative value and the second representative value; and
generate the spatial feature using the spatial weight matrix and the image feature.

3. The electronic system of claim 2, wherein the first operation is a max pooling applied, in the channel direction, to the image feature, and the second operation is an average pooling applied, in the channel direction, to the image feature.

4. The electronic system of claim 1, wherein the execution of the code configures the processor to:
determine a third representative value by performing, in a spatial dimension, a third operation using the image feature;
determine a fourth representative value by performing, in the spatial dimension, a fourth operation using the image feature;
generate a channel weight matrix based on a relationship between channels that is learned using the third representative value and the fourth representative value; and
generate the channel feature using the channel weight matrix and the image feature.

5. The electronic system of claim 4, wherein the third operation is a max pooling applied, in the spatial direction, to the image feature, and the fourth operation is an average pooling applied, in the spatial direction, to the image feature.

6. The electronic system of claim 1, wherein the execution of the code configures the processor to:
generate a first fused feature by fusing, in a channel dimension, the spatial feature with the channel feature;
perform a fifth operation using the first fused feature;
determine a respective weight for each channel of the first fused feature by learning a relationship between channels by performing a sixth operation using a result of the performed fifth operation; and
generate the fused feature by applying the respective weight for each channel to the first fused feature.

7. The electronic system of claim 6,
wherein the performing of the fifth operation includes performing global average pooling on the first fused feature, a first linear transformation on a result of the global average pooling, and a second linear transformation on a result of the first linear transformation to have a feature size equal to a feature size of the result of the global average pooling, and
wherein the sixth operation includes applying an activation function to the result of the performed fifth operation.

8. The electronic system of claim 1, wherein the execution of the code configures the processor to:
respectively select at least one specialized model for each of the at least two image processing tasks by using a corresponding routing function of each of the at least two image processing tasks;
set a respective weight for the respectively selected at least one specialized model for each of the at least two image processing tasks; and
generate the corresponding customized task feature for each of the at least two image processing tasks by fusing, according to the set respective weight for the respectively selected at least one specialized model for each of the at least two image processing tasks, results of processing the fused feature by the respectively selected at least one specialized model for each of the at least two image processing tasks.

9. The electronic system of claim 8, wherein the execution of the code configures the processor to:
normalize the fused feature; and
generate the corresponding customized task feature for each of the at least two image processing tasks by fusing, according to the set respective weight for the respectively selected at least one specialized model for each of the at least two image processing tasks, results of processing the normalized fused feature by the respectively selected at least one specialized model for each of the at least two image processing tasks.

10. The electronic system of claim 8, wherein a routing function, among the corresponding routing functions, and a specialized model, among the respectively selected at least one specialized model for each of the at least two image processing tasks, are implemented as a multilayer perceptron (MLP).

11. The electronic system of claim 1, wherein the extraction of the image feature, the respective generation of the spatial feature and the channel feature, the generation of the fused feature, and the generation of the respective results of the at least two image processing tasks are performed using an artificial intelligence (AI) model that was trained based on respective classification losses of the at least two image processing tasks and a class-balanced loss through adjustment of hyperparameters of an in-training AI model based on the respective classification losses and the class-balanced loss.

12. The electronic system of claim 1, wherein the generating of the respective results of the at least two image processing tasks comprises performing the generating of the corresponding customized task feature for each of the at least two image processing tasks, and respectively decoding the corresponding customized task feature for each of the at least two image processing tasks to generate the respective results of the at least two image processing tasks.

13. A processor-implemented method for performing at least two image processing tasks with respect to an image, the method comprising:
extracting an image feature of the image;
respectively generating a spatial feature and a channel feature dependent on the image feature;
generating a fused feature, for the image, dependent on the spatial feature and the channel feature; and
generating respective results of the at least two image processing tasks based on a corresponding customized task feature for each of the at least two image processing tasks generated using the fused feature.

14. The method of claim 13, wherein the generating of the spatial feature comprises:
determining a first representative value by performing, in a channel dimension, a first operation using the image feature;
determining a second representative value by performing, in the channel dimension, a second operation using the image feature;
generating a spatial weight matrix using the first representative value and the second representative value; and
generating the spatial feature using the spatial weight matrix and the image feature.

15. The method of claim 13, wherein the generating of the channel feature comprises:
determining a third representative value by performing, in a spatial dimension, a third operation using the image feature;
determining a fourth representative value by performing, in the spatial dimension, a fourth operation using the image feature;
generating a channel weight matrix based on a relationship between channels that is learned using the third representative value and the fourth representative value; and
generating the channel feature using the channel weight matrix and the image feature.

16. The method of claim 13, wherein the generating of the fused feature comprises:
generating a first fused feature by fusing, in a channel direction, the spatial feature with the channel feature;
performing a fifth operation using the first fused feature;
determining a respective weight for each channel of the first fused feature by learning a relationship between channels by performing a sixth operation using a result of the performed fifth operation; and
generating the fused feature for the image by applying the respective weight for each channel to the first fused feature.

17. The method of claim 13, wherein the generating of the respective customized task features comprises:
respectively selecting at least one specialized model for each of the at least two image processing tasks by using a corresponding routing function of each of the at least two image processing tasks;
setting a respective weight for the respectively selected at least one specialized model for each of the at least two image processing task; and
generating the corresponding customized task feature for each of the at least two image processing tasks by fusing, according to the set respective weight for the respectively selected at least one specialized model for each of the at least two image processing tasks, results of processing the fused feature by the respectively selected at least one specialized model for each of the at least two image processing tasks.

18. The method of claim 17, further comprising:
normalizing the fused feature,
wherein the generating of the corresponding customized task features for each of the at least two image processing tasks comprises:
generating the corresponding customized task features for each of the at least two image processing tasks by fusing, according to the set respective weight for the respectively selected at least one specialized model for each of the at least two image processing tasks, results of processing the normalized fused feature by the respectively selected at least one specialized model for each of the at least two image processing tasks.

19. The method of claim 17, wherein a routing function, among the corresponding routing functions, and a specialized model, among the respectively selected at least one specialized model for each of the at least two image processing tasks, are implemented as a multilayer perceptron (MLP).

20. The method of claim 13, wherein the extracting of the image feature, the respective generating of the spatial feature and the channel feature, the generating of the fused feature, and the generating of the respective results of the at least two image processing tasks are performed using an artificial intelligence (AI) model.
